(19) United States
(12) Patent Application Publication
(10) Pub. No.: US 2016/0132932 A1
(43) Pub. Date: May 12, 2016

(54) Hyper-local content push and pay method for mobile devices

(71) Applicant: Laurance Stephen LINGVAY, West Melbourne, FL (US)

(72) Inventor: Laurance Stephen LINGVAY, West Melbourne, FL (US)

(21) Appl. No.: 14/536,196

(22) Filed: Nov. 7, 2014

(51) Int. Cl. G06Q 30/02; H04L 29/08

(52) U.S. Cl. CPC G06Q 30/0267; H04L 67/26

(57) ABSTRACT

A method and system for providing hyper-local content push and a billing model is provided. The hyper-local content push (HYPER-LOCAL CONTENT PUSH) advertising system sends the user relevant content that have associated physical visit locations. The system provides relevant content (coupon and advertising) to the mobile devices of users through local hotspot(s) utilizing wireless networking technology (e.g. Wi-Fi), when the user is in the vicinity of or examining locations in the vicinity of a visit location. When the user comes into range of visit locations where the Wi-Fi hotspot(s) have been deployed, associated servers will push content to the user as they traverse the local Wi-Fi zone. The content includes coupons that can be requested by the user client that could include location relevant or on-location specials that are only available to the user by coming into the local hotspot Wi-Fi zone physically and in person. If the user subsequently requests the available coupon of the HYPER-LOCAL CONTENT PUSH system or follows the hyperlinks of provided advertisements, the system provides for billing an advertiser or seller under the assumption that but for the coupon or advertisement; the user would not have visited the visit location and or made a purchase.

### CROSS-REFERENCE TO RELATED APPLICATIONS

This application claims the benefit of provisional U.S. Patent Application No. 61/962,497, filed Nov. 8, 2013 and entitled “Hyper-local content push and pay method for mobile devices”, which is hereby incorporated by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### TECHNICAL FIELD

The present description relates to transferring (pushing) relevant advertising data (coupons and advertisements) to a mobile device without having to determine the location of the mobile device because the mobile device will be in the working range of, and in communication with a content server of local and relevant location.

### BACKGROUND

Current mobile devices are widely employed by their users to map or find locations of interest. Further when the search involves, not just simply navigation but, a search to find goods and services for sale, the search engines return contextual data the includes advertisements that are subsequently displayed on the users mobile device interface or commonly, an internet browser. The latter is a subject of great importance to the providers of these goods and services who spend enormous amounts of money on advertising to the searching users. Unfortunately for the advertisers, these users are mobile and usually in route to some specific location to conduct commerce making it difficult to accurately target the advertising to the user.

Hence the advertisers have subsequently turned to a myriad of methods to determine the location of their potential customer so as to, as precisely as possible, target their advertisements in hopes of inducing the potential buyer to purchase from them. The latter usually involves elaborate resources and methods to simply locate the potential buyer and place advertising data relevant to the buyers search, in the buyer's hands, in this case on their mobile device, at best possible moment in time and space (i.e. location of the buyer relative to the advertiser or seller).

Hyper local content push (HLCP) embodied in this invention circumvents all of these problems in a way that reaches the customer directly with information they want that can be used immediately. The concept of hyper local advertising relies on the use of Local Area Network or Wi-Fi hotspots based on wireless Ethernet 802.11 or other similar local area (WLAN), personal area networks (PAN) or similar wireless networks. The key feature here is that Wi-Fi or similar technology is a broadcast system that utilizes a broadcast station ID which that can be leveraged so that the user can interact with the system of local importance to the user. When the user or customer comes into range of advertisers or retailers where the Wi-Fi hotspot(s) have been deployed, client-side software conducts a transaction with the hotspot servers so coupons and advertisements can be pushed out automatically to them as they traverse the local Wi-Fi zone. The coupons that get pushed can include an in-store special that's only available to the user by coming into the hotspot Wi-Fi zone physically and in person.

Further, this technology will allow the user's location to be identified within the proximity of the location of interest to within a few tens meters. Further multiple Wi-Fi hotspots could be used to further improve the users location for pushing very focused content to the user such as from one store to the next where the stores are adjacent to each other further could be used to track the users movements and develop further shopping and use habits of the user. However, none of the foregoing is necessary for the invention disclosed herein to fulfill is primary function.

Finally because the advertising is pushed to the user, similar to delivering printed advertising to a user's mail box at home, the advertising is paid for upfront by the advertiser. The current invention has an additional revenue benefit, in that the users can request or download coupons from the system whereby an additional fee is paid to the content provider by the advertiser.

### BRIEF SUMMARY OF THE INVENTION

Not Provided

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an example HLCP system with mobile devices in accordance with some embodiments discussed herein.

FIG. 2 illustrates a range and proximity diagram of an HLCP system and/or mobile devices according to some embodiments discussed herein.

### DETAILED DESCRIPTION OF THE INVENTION

In general, example embodiments of the present invention provide herein systems, methods and computer readable storage media for facilitating the transfer (pushing) of relevant advertising data (coupons and advertisements) to a mobile device without having to determine the location of the mobile device for the content to be relevant or of immediate value to the user. Among other things, embodiments discussed herein can be configured to transfer relevant advertising data to at least one mobile device as the user comes into the working range of the HLCP system. The location of the recipient mobile device is not necessary because the mobile device will in the working range of and in communication with a content server, which by its physical placement relative to the advertisers makes it local and relevant to the user and the advertiser. Further because the working range of the system is limited to a small geographical location by the nature of the network (e.g WLAN) the provided content is both timely and useful to the user as they visit local places of interest where they may be completing making purchases.

Other systems, methods, and features will be, or will become, apparent to one with skill in the art upon examination of the following figures and detailed description. It is intended that all such additional systems, methods, features and be included within this description, be within the scope of the disclosure, and be protected by the following claims.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like

Further, as used herein, the terms “relevant advertising data”, “relevant content”, “content,” “advertising”, “advertising and coupons” and similar terms may be used interchangeably to refer to data capable of being captured, transmitted, received, displayed and/or stored in accordance with various example embodiments. Further, these terms are more specific to the goal of the invented system which is to provide timely and useful discount shopping relevant content to the user as they visit local places of interest where they may be completing making purchases.

Further the term “advertiser” refers to any entity that may want to advertise, for a fee, relevant content to the user such as a person, an educational institution, a company, a business, a nonprofit organization, a government agency, and so on.

Further the term “Working range”, “in proximity”, “working distance”, “in range” or similar terms may be used interchangeably to refer to a range at which the radio transceivers of the wireless communications interface are functioning properly such that data can reliably be transferred between devices. Thus, use of any of the foregoing terms should not be taken to limit the spirit and scope of the disclosure.

The principles and embodiments of the present invention now will be described more fully herein with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

Further, any such computer program instructions and/or other type of code described herein may be loaded onto a computer, processor or other programmable apparatuses circuitry to produce a machine, such that the computer, processor or other programmable circuitry that executes the code may be the means for implementing various functions, including those described herein.

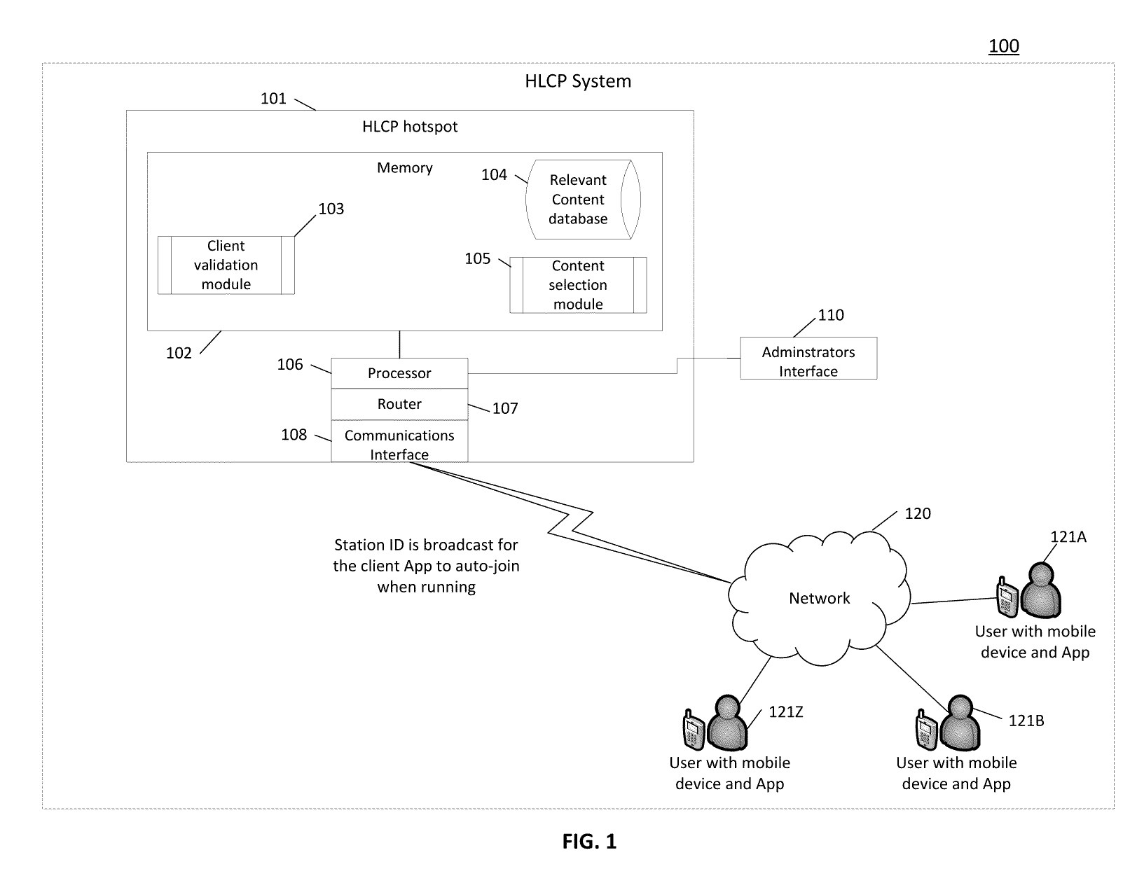

Referring to FIG. 1, FIG. 1 illustrates a system 100 including an example network architecture, which may include one or more devices and sub-systems that are configured to implement some embodiments discussed herein. A number of users may each have a mobile device 121A, 121Z, such as a smartphone, a laptop, a mobile computing device, a tablet computing device, and/or the like. As shown in FIG. 1, A Hyper-local Content Push (HLCP) hotspot 101 may be coupled to one or more mobile devices 121A, 121Z via a communications interface 108 that is configured to communicate with network 120.

Network 120 may include any wireless communication network including, for example, a wireless local area network (WLAN), wireless personal area network (WPAN), metropolitan area network (MAN), or the like, as well as any hardware, software and/or firmware required to implement it (such as, e.g., network routers, etc.). For example, network 120 may include IEEE 802.11 Wi-Fi, and/or IEEE 802.15 Bluetooth networking. Further, the network 120 may include a public network, such as the Internet, a private network, such as an intranet, or combinations thereof, and may utilize a variety of networking and/or communication protocols now available or later developed including, but not limited to TCP/IP based networking protocols.

Returning to FIG. 1, system 100 includes an HLCP hotspot 101, which may include, for example, a processor 106, memory 102, a client validation module 103, a content selection module 105, and at least one content relevant database 104. The client validation module 103 and content selection module 105 can be any suitable network server and/or other type of processing device. The relevant content database 104 can be any suitable network database configured to store relevant advertising data, such as data corresponding to advertisements of one or several business proprietors in a mall, shopping plaza or an outdoor collection of shops. In this regard, HLCP system 100 may include for example, at least one backend data server, network database or cloud computing device, among other things. As discussed herein, the mobile devices 121A, 121Z may be any suitable mobile device, such as a cellular phone, tablet computer, smartphone, etc., or other type of mobile processing device that may be used for any suitable purpose.

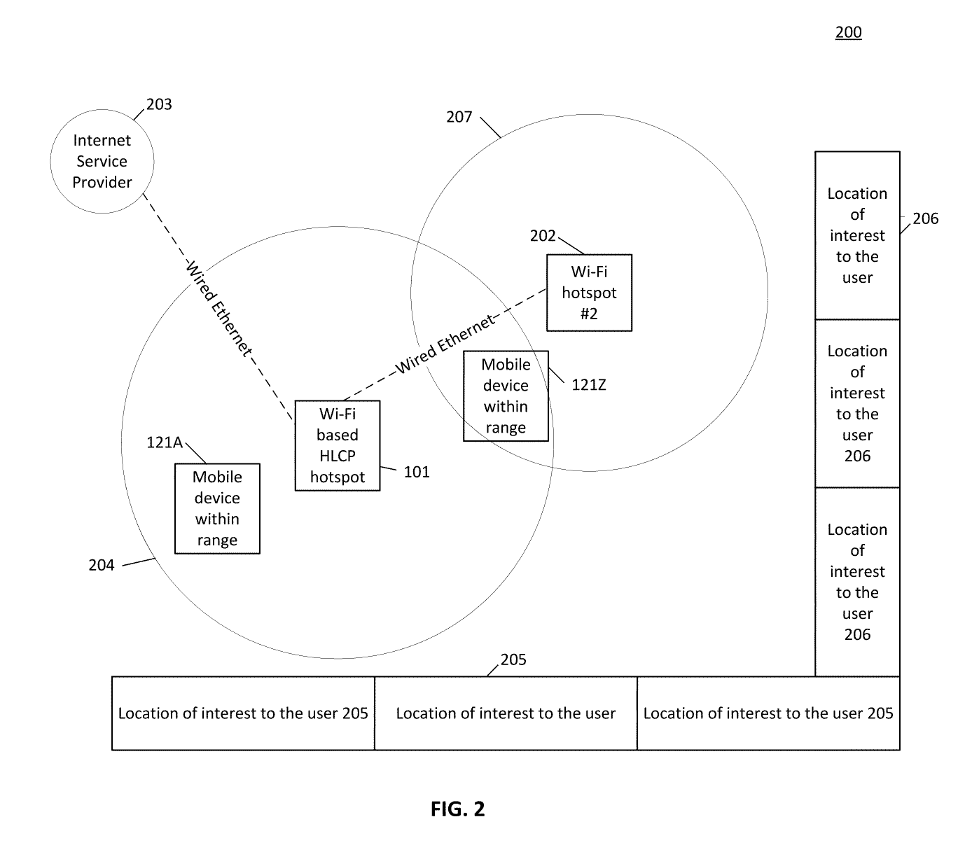

FIG. 2 illustrates one example for the use of the content push system; 101 is the hotspot which broadcasts the network 120 with Wi-Fi to an effective range of about 70 meters. In this example the user is in a shopping mall next to stores 205, As the user comes into range of the hotspot 101, their client app 121A (running in their device's memory) notifies the user of an auto join to the network 120, depicted in this illustration as 204. Advertisements, of the proprietors of the various stores 205 near the user location, are pushed to the user's device client. The user client also receives a notification that a coupon is available for download. The user can them choose to download the coupon and visit one of the locations of interest to use the coupon for discount purchase.

The fundamental feature of the embodied invention is realized in the fact that the range of the Wi-Fi hotspot (about 70 m) provides for natural relevant content delivery since the users and proprietors are all in the immediate vicinity of each other. In other words the range limits of the hotspot provide targeted content delivery without having to locate the user.

Further as illustrated in this embodiment, as a user moves into another area of the shopping mall, other hotspots 202 that are closer to other proprietors 206, push different content to a similar application running on the users mobile device 121Z

Returning to FIG. 2, the remaining elements in the diagram show the wired Ethernet connection to the HLCP hotspot 101, whereby the hotspot is connected to an Internet service provider portal 203 somewhere on site so that content can be monitored and updated over the Internet.

The above disclosed subject matter is to be considered illustrative, and not restrictive, and the appended attached claims are intended to cover all such modifications, enhancements, and other embodiments, which fall within the true spirit and scope of the description. Further, the illustrations described herein intended to provide a general understanding of the structure of various embodiments. The illustrations are not intended to serve as a complete description of all of the elements and features of apparatus, processors, and systems, thus to the maximum extent allowed by law, the scope is to be determined by the broadest permissible interpretation of the following claims and their equivalents, and shall not be restricted or limited by the foregoing detailed description.

What is claimed:

1. A method and system referred to as hyper-local content push system, comprising: at least one mobile processor based host with a client application program, one processor based host with a server application program, wireless network transceivers for both the client and server, software instructions for execution by the processors and other computer components that are configured to, when executed by the client and server: push relevant content, such as coupons, advertising and other information, from the server to the client application of each of a plurality of users in a local geographic area, known as a wireless hotspot, when the user comes into the working proximity of the hotspot.

2. A method and system of claim 1 that uses Wireless Ethernet, Bluetooth, or other local area networking hosted by the hyper-local content push hotspot.

3. A method and system of claim 1 where there can be multiple hyper-local content push hotspots working in conjunction with each other to cover a larger area then one single hyper-local content push hotspot can meaningfully cover to provide relevant content to the user client application when the user comes into working proximity of the hotspot.

4. A method and system of claim 1 whereby the user's mobile device interacts with the hotspot using the hotspots broadcast or station ID name or other unique wireless device number.

5. A method and system of claim 1 whereby the hotspot broadcast or station ID name or other unique wireless device number determines what relevant content should be pushed to the user client application.

6. A method and system of claim 1 whereby relevant content is pushed to the user by coming into working distance of a hotspot configured as a standalone kiosk in the vicinity of a place of local interest, such as a directory kiosk, which is embodied as a hyper-local content push hotspot for pushing the relevant content to the user Application.

7. A method and system of claim 1 further configured to allow the user to join the hyper-local content push system as a member for a membership fee whereby becoming a member entitles the user to special relevant content advertising and further discounted offers.

8. A method and system of claim 1 that pushes relevant content to the user client whereby the client application then notifies the user that a relevant content is available for viewing or download.

9. A system and method of claim 1 that does not does not rely on predictive algorithms and filters to determine where a user is located geographically and what relevant content should to be pushed to the user client.

10. A method and system of claim 1 further configured to generate a code of the day that is imprinted on the relevant content so that transactions can be tracked and that counterfeit can be avoided.

11. A computer program product comprising: at least one computer readable non-transitory memory medium having program code instructions stored thereon, the program code instructions which when executed by the mobile host apparatus cause the apparatus at least to: function as a client software application program, known as an app, that are configured to and when executed by the client, receives the transfer of relevant content from the server to the user, when the user comes into working proximity of the hotspot.

12. A method and system of claim 11 further configured to allow the user to download the relevant content by selecting an action in the Application.

13. A method and system of claim 11 whereby the action of downloading the relevant content becomes a method for billing the advertiser.

14. A method and system of claim 11 further configured whereby hyperlinked relevant content is pushed to and displayed on the user's client application.

15. A method and system of claim 11 further configured whereby following or clicking a hyperlinked advertisement provides for a method for billing the advertiser.

16. A method and system of claim 11 further configured to allow the user to receive and complete a survey for the specific seller which becomes a means of providing market effectiveness to the seller.

17. A system and method of claim 11 that does not does not rely solely on GPS location technology, cellular triangulation, or client initiated internet search, to determine what relevant content should to be pushed to the user client.
